(19) United States
(12) Patent Application Publication
(10) Pub. No.: US 2007/0065193 A1
(43) Pub. Date: Mar. 22, 2007

(54) Fixing device having pressure member and image forming apparatus including the same

(75) Inventors: Jae-hyeok Jang, Seoul (KR); Dong-jin Seol, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/483,604

(22) Filed: Jul. 11, 2006

(30) Foreign Application Priority Data
Sep. 21, 2005 (KR) 2005-87886

(51) Int. Cl. G03G 15/20

(52) U.S. Cl. 399/329

(57) ABSTRACT

A fixing device includes a pressure member, a heat roller, a pressure roller disposed opposite to the heat roller and pressing the heat roller, and a fixing belt driven between the heat roller and the pressure roller. The pressure member is positioned upstream of the pressure roller in a direction that a printing medium is conveyed, presses the fixing belt along an outer circumferential surface of the heat roller, and fixes a toner image transferred to the printing medium.

### CROSS-REFERENCE TO RELATED APPLICATIONS

This application claims priority under 35 U.S.C. §119(a) from Korean Patent Application No. 2005-87886, filed Sep. 21, 2005, the disclosure of which is hereby incorporated herein by reference in its entirety.

### BACKGROUND OF THE INVENTION

1. Field of the Invention

The present general inventive concept relates to a fixing device and an image forming apparatus including the same, and more particularly, to a fixing device to increase an area of a fixing nip and an image forming apparatus including the same.

2. Description of the Related Art

A conventional electrophotographic image forming apparatus is being widely used in a laser printer, a facsimile, a duplicator, and the like. In the conventional electrophotographic image forming apparatus, an electrostatic latent image is formed on a photoconductor by a laser. The electrostatic latent image formed on the photoconductor is developed into a visible image by a toner. The visible image developed by the toner (referred to as “toner image”) is transferred to a printing medium. The printing medium to which the toner image is transferred is subjected to heat and pressure. Thus, the toner image is fixed on the printing medium to form a final image.

In general, a fixing device includes a heat roller and a pressure roller. The heat roller is provided with a heat source, such as a halogen lamp mounted therein, and heated by radiation transmitted from the heat source. The pressure roller is disposed opposite to the heat roller and is pressed toward the heat roller. At this point, a fixing nip is formed between the heat roller and the pressure roller. When passing through the fixing nip, the printing medium is subjected to heat and pressure by the heat roller and the pressure roller, thereby fixing a toner image on the printing medium.

Currently, an attempt has been made to increase an area of the fixing nip in response to an increase in speed of the electrophotographic image forming apparatus. This is intended to increase the area of the fixing nip to lengthen a time during which the printing medium stays at the fixing nip, thereby enabling high-speed fixing.

In order to increase the area of the fixing nip, there are two conventional techniques; one is to increase a diameter of the heat roller and/or pressure roller, and the other is to increase a thickness of an elastic layer formed on the heat roller and/or pressure roller. These techniques have a problem in that, as the dimensions of the roller(s) are increased, the size of the image forming apparatus is increased, which results in increase of a warm-up time.

Korean Utility Model Publication No. 1998-015582 discloses a fixing device including a belt that is supported by a pressure roller and an idle roller and that is pressed by the pressure roller, and a heating section that applies heat to the belt. An area of a fixing nip is increased by using the belt supported by the idle roller instead of the heat roller.

European Patent No. EP1193567 discloses a fixing device including a pressure roller and an auxiliary roller disposed on a heat roller, and a belt wound around the pressure roller and auxiliary roller. A printing medium is introduced toward the auxiliary roller, and an image is fixed through a fixing nip formed between the auxiliary roller and the pressure roller.

Generally, there are various rollers, such as a heat roller, an idle roller, and an auxiliary roller, used for increasing an area of a fixing nip. For example, the heat roller comes into contact with both the idle roller and the auxiliary roller via a belt, and the idle and auxiliary rollers are spaced apart from each other by a predetermined distance and a belt is wound around the idle and auxiliary rollers. The fixing nip may be located on a part of the belt between the idle and auxiliary rollers and the heat roller coming into contact with the part of the belt. In this case, the area of the fixing nip can be increased. However, there is a problem that, in the area of the fixing nip, a pressure of a part of the belt which is not pressed by the rollers is relatively lower than a pressure of another part of the belt which is pressed by the rollers. Further, there is a problem that an irregular pressure at the fixing nip causes an irregular image of the fixed toner image, thereby deteriorating image quality formed on the printing medium.

### SUMMARY OF THE INVENTION

The present general inventive concept provides a fixing device to increase an area of a fixing nip, and an image forming apparatus including the same.

The present general inventive concept also provides a fixing device to make a pressure of a fixing nip uniform, and an image forming apparatus including the same.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a fixing device, including a heat roller, a pressure roller disposed opposite to the heat roller to press the heat roller, a fixing belt to be driven between the heat roller and the pressure roller and pressed by the pressure roller, and to fix a toner image on a printing medium as the printing medium passes between the fixing belt and the heat roller, and a pressure member positioned upstream of the pressure roller in a direction in which the printing medium is conveyed, to press the fixing belt along an outer circumferential surface of the heat roller, and to fix the toner image on the printing medium as the printing medium passes between the pressed fixing belt and the heat roller.

The pressure member may have an elastic layer on an outer surface thereof in contact with the fixing belt. Further, the fixing device may include a resilient member to press the pressure member toward the heat roller.

The fixing device may further include a pinch roller to rotate in a direction opposite to the pressure roller, wherein the fixing belt is interposed between the pinch roller and the pressure roller.

The pressure member may include a pressure portion formed along the outer circumferential surface of the heat roller, and a guide portion to guide the fixing belt toward the pressure portion.

The pressure member may include a pressure zone formed along the outer circumferential surface of the heat roller, and a guide zone along which the wound fixing belt is moved to guide the fixing belt toward the pressure zone.

The foregoing and/or other aspects and utilities of the present general inventive concept may also be achieved by providing a fixing device to fix a toner image transferred to a printing medium passing through a plurality of fixing nips, the device including first and second rollers rotatable in opposite directions to each other to form a first fixing nip, a fixing belt to be driven between the first and second rollers, and a pressure member to press the fixing belt along an outer circumferential surface of the first roller and to form a second fixing nip between the first roller and the fixing belt corresponding to the pressure member, in which, after passing through the second fixing nip, the printing medium passes through the first fixing nip formed between the first roller and the fixing belt corresponding to the second roller while the second roller presses the first roller.

The foregoing and/or other aspects and utilities of the present general inventive concept may also be achieved by providing an image forming apparatus, including an image forming section to transfer a toner image from a photoconductor to a printing medium through, and a fixing device to fix the toner image on the printing medium and including a heat roller to be heated to a fixing temperature, a pressure roller disposed opposite to the heat roller to press the heat roller, a fixing belt to be driven between the heat roller and the pressure roller and pressed by the pressure roller, and to fix the toner image on the printing medium as the printing medium passes between the fixing belt and the heat roller, and a pressure member positioned upstream of the pressure roller in a direction in which the printing medium is conveyed, to press the fixing belt along an outer circumferential surface of the heat roller, and to fix the toner image on the printing medium as the printing medium passes between the pressed fixing belt and the heat roller.

The foregoing and/or other aspects and utilities of the present general inventive concept may also be achieved by providing a fixing device usable in an image forming apparatus, including a heat roller, a belt, a pressure roller to press a first portion of the belt toward a first portion of the heat roller to form a first nip, and a pressure member spaced-apart from the pressure roller to press a second portion of the belt toward a second portion of the heat roller to form a second nip.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view illustrating an image forming apparatus according to an embodiment of the present general inventive concept;

FIG. 2 is a side view illustrating a fixing device of the image forming apparatus of FIG. 1 according to an embodiment of the present general inventive concept;

FIG. 3 is a side view illustrating a fixing device of the image forming apparatus of FIG. 1 according to another embodiment of the present general inventive concept;

FIG. 4 is a side view illustrating a fixing device of the image forming apparatus of FIG. 1 according to another embodiment of the present general inventive concept; and

FIG. 5 is a side view illustrating a fixing device of the image forming apparatus of FIG. 1 according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

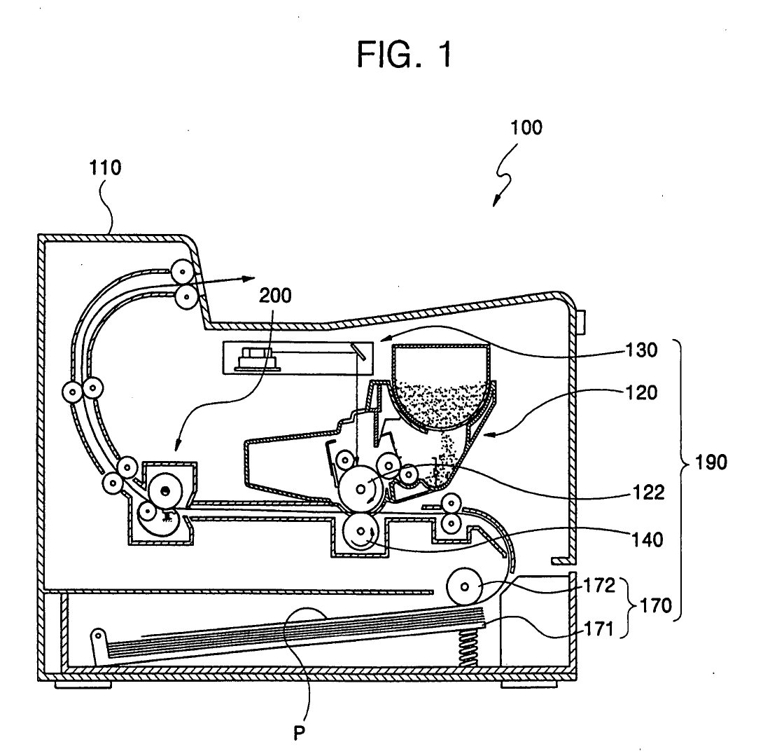

FIG. 1 is a view illustrating an image forming apparatus 100 according to an embodiment of the present general inventive concept.

Referring to FIG. 1, the image forming apparatus 100 includes a main body 110, and an image forming section 190 and a fixing device 200 provided in the main body 110.

The image forming section 190 includes a paper feed unit 170, a development unit 120, a light scanning unit 130, and a transfer unit 140.

The paper feed unit 170 is provided on a lower portion of the main body 110 to feed a printing medium P toward the development unit 120. The paper feed unit 170 includes a paper feed cassette 171 on which printing media P are loaded, and a pick-up roller 172 that picks up the printing media P one by one.

The light scanning unit 130 forms an electrostatic latent image on a photoconductor 122 of the development unit 120 using laser light. The development unit 120 develops a toner image on the photoconductor 122 on which the electrostatic latent image is formed. The transfer unit 140 transfers the toner image to the printing medium P.

The image forming section 190 constructed in this manner is well known to those skilled in the art, and so its detailed description will be omitted. A black and white image forming apparatus will be described below as an example, but the present general inventive concept is not limited to the black and white image forming apparatus, and thus encompasses, for example, a color image forming apparatus and an image forming apparatus for simplex printing or duplex printing.

The fixing device 200 fixes the transferred toner image on the printing medium P using heat and pressure. The printing medium P on which the image is fixed is discharged outside the main body 110 when the fixing of the image is completed.

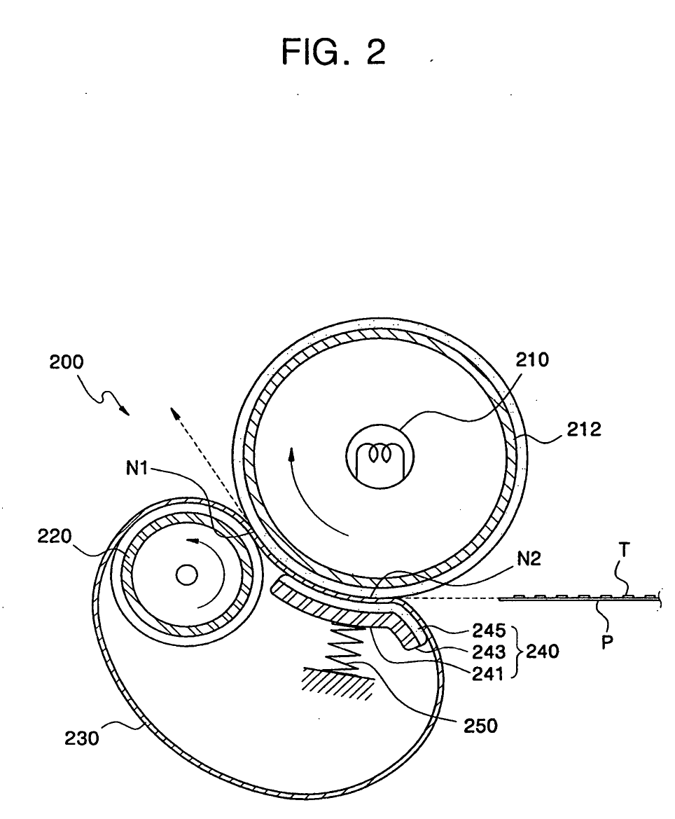

FIG. 2 is a side view illustrating the fixing device 200 of the image forming apparatus 100 of FIG. 1 according to an embodiment of the present general inventive concept.

Referring to FIG. 2, the fixing device 200 of FIG. 1 can include a heat roller 212, a pressure roller 220, a fixing belt 230, and a pressure member 240.

The heat roller 212 can be a cylindrical pipe formed of a metal, such as aluminum or stainless steel. The heat roller 212 is heated to a fixing temperature by a heat source, such as the internal heat source 210 illustrated in FIG. 2. The heat source may be, for example, a halogen lamp, or another heat source including a heater. Further, the heat source may be disposed inside or outside the heat roller 212.

The heat roller 212 is provided with an elastic layer (made of, for example, silicon rubber, urethane, or foam resin) on an outer surface of the heat roller 212. The elastic layer may further have a release layer (made of, for example, fluorocarbon resin (Teflon)) on an outer surface of the elastic layer.

The pressure roller 220 is disposed opposite to the heat roller 212 and presses the heat roller 212 through the fixing belt 230. The pressure roller 220 can be a pipe formed of a metal, such as aluminum or stainless steel, and can have an elastic layer (made of, for example, silicon rubber, urethane, or foam resin) on an outer surface of the pressure roller 220. The pressure roller 220 is provided with a pressure mechanism (not illustrated) in order to press the heat roller 212 through the fixing belt 230.

The fixing belt 230 travels along the circumference of the pressure roller 220, and guides the conveyed printing medium P toward the heat roller 212. Further, the fixing belt 230 is pressed by the pressure roller 220 and/or the pressure member 240, thereby forming fixing nips N1 and N2 together with the heat roller 212 to fix the toner image.

The fixing belt 230 may be made of, for example, a polyimide resin or a metal, such as nickel or stainless steel. The fixing belt 230 may be provided with an elastic layer (for example, made of silicon rubber, urethane, or foam resin) on at least one surface thereof. Further, the elastic layer may have a release layer formed of fluorocarbon resin.

At least one of the heat roller 212 and the pressure roller 220 is driven by a driving mechanism (not illustrated). Thus, the heat roller 212 and/or the pressure roller 220 forces the fixing belt 230 to pass between the heat roller 212 and the pressure roller 220. As a result, the fixing belt 230 obtains driving force while passing between the heat roller 212 and the pressure roller 220, and circulates around the pressure roller 220 and pressure member 240 by the driving force. Further, the pressure of the pressure roller 220 on the heat roller 212 through the fixing belt 230 causes the second fixing nip N2 to be formed between the fixing belt 230 and the heat roller 212, in addition to the first fixing nip N1 (described below).

The pressure member 240 is provided on an upstream side of the pressure roller 220 in the direction in which the printing medium P is conveyed prior to entering the second fixing nip N2. The pressure member 240 presses a part of the outer circumferential surface of the heat roller 212 through the fixing belt 230, thereby forming the second fixing nip N2 between the fixing belt 230 and the heat roller 212. In other words, the first fixing nip N1 is formed downstream of the second fixing nip N2 in the conveyed direction of the printing medium P, and thus the printing medium P conveyed from the image forming section 190 undergoes the fixing process while sequentially passing through the second fixing nip N2 and then the first fixing nip N1.

The pressure member 240 includes a pressure portion 241 extending in a direction along the outer circumferential surface of the heat roller 212 by a predetermined length, and a guide portion 243 to guide the fixing belt 230 toward the pressure portion 241.

The pressure portion 241 is formed to correspond to a profile of the outer circumferential surface of the heat roller 212, and brings the heat roller 212 into contact with the fixing belt 230. When the pressure portion 241 presses the fixing belt 230 toward the heat roller 212, a uniform pressure is applied to the second fixing nip N2 formed between the fixing belt 230 and the heat roller 212.

The pressure portion 241 may have a length ranging from a location where the printing medium P having the toner image T is introduced toward the heat roller 212 to a location where the first fixing nip N1 begins. However, the pressure portion 241 may have a length smaller than the length described above. The length of the area at which the pressure portion 241 presses the heat roller 212 is equal to the length of the second fixing nip N2. The second fixing nip N2 can have a length that is larger than a length of the first fixing nip N1.

In the present general inventive concept, the second fixing nip N2 is additionally formed by the pressure member 240, in addition to the first fixing nip N1 formed by the pressure roller 220, so that a total fixing area is increased. Further, the second fixing nip N2 is formed to extend in a direction along the outer circumferential surface of the heat roller 212 with the pressure member 240 brought into contact with the fixing belt 230, so that pressure applied to the second fixing nip N2 by the pressure member 240 is always uniform.

The guide portion 243 guides the fixing belt 230 toward the pressure portion 241. To this end, the guide portion 243 is bent in a direction opposite to the heat roller 212 by a predetermined angle.

The fixing belt 230 is wound around the pressure roller 220 and the pressure member 240. The fixing belt 230 travels along the outer circumferential surface of the pressure roller 220, and then comes into contact with the guide portion 243. The fixing belt 230 contacting the guide portion 243 enters the second fixing nip N2 toward the pressure roller 220 through the guide portion 243.

The fixing belt 230 travels through the first and second fixing nips N1 and N2 under strong tension. However, such tension is hardly applied to the fixing belt 230 after the fixing belt 230 passes the first fixing nip N1 but before the fixing belt 230 contacts the guide portion 243. In other words, the tension applied to regions of the fixing belt 230 other than the first and second fixing nips N1 and N2 is minimized, thereby increasing a lifespan of the fixing belt 230.

The pressure member 240 may be made of a metal, such as aluminum or stainless steel. In this case, in order to enhance a fixing efficiency at the second fixing nip N2, a heating element (not illustrated) may be provided around the pressure member 240.

Alternatively, the pressure member 240 may be formed of a positive temperature coefficient (PTC) material so that the pressure member 240 itself emits heat. The PTC material refers to a material in which electric resistance is sharply increased when temperature is increased. Thus, when the PTC material is supplied with an electric current, the temperature is increased. The resistance of the PTC material is increased when the temperature reaches a predetermined temperature or higher, and the current is reduced to a predetermined voltage according to Ohm's law, and thus a quantity of emitted heat is reduced. Thus, when the temperature is lowered, the resistance of the PTC material is again decreased, and the resulting current is increased. If the pressure member 240 is formed of the PTC material, it is not necessary to provide a separate heating element. Thus, it is possible to enhance the fixing effect at the second fixing nip N2 through the spontaneous heat emission of the pressure member 240.

The pressure member 240 in contact with the fixing belt 230 is provided with an elastic layer 245 made of, for example, silicon rubber, urethane, foam resin, and the like. The elastic layer 245 enables the pressure portion 241 to be in closer contact with the fixing belt 230, and reduces friction between the guide portion 243 and the fixing belt 230. Further, a release layer (not illustrated) may be formed on the elastic layer 245.

In order to press the pressure member 240 toward the heat roller 212, a resilient member 250 is provided. The resilient member 250 has one end fixed to the main body 110 and another end coupled to the pressure member 240 to push the pressure member 240 toward the heat roller 212 by an elastic force.

Hereinafter, operation of the image forming apparatus of FIG. 1 according to the embodiment of the present general inventive concept will be described with reference to FIGS. 1 and 2.

The printing medium P is picked up from the paper feed cassette 171 of the paper feed unit 170 and guided toward the development unit 120. An electrostatic latent image is formed on the photoconductor 122 and is developed by a toner to form a toner image T. The toner image T developed by the toner is transferred to the printing medium P by the transfer unit 140.

The heat roller 212 of the fixing unit 200 maintains a predetermined fixing temperature using the heat source 210. The printing medium P, on which the toner image T is formed, is introduced into the second fixing nip N2 formed by the pressure member 240 pressing the heat roller 212 through the fixing belt 230, and then the toner image T is fixed on the printing medium P.

Subsequently, the printing medium P is conveyed along the fixing belt 230, introduced into the first fixing nip N1, and then the toner image T is further fixed on the printing medium P. The printing medium P on which the image formation is fixed is then discharged outside.

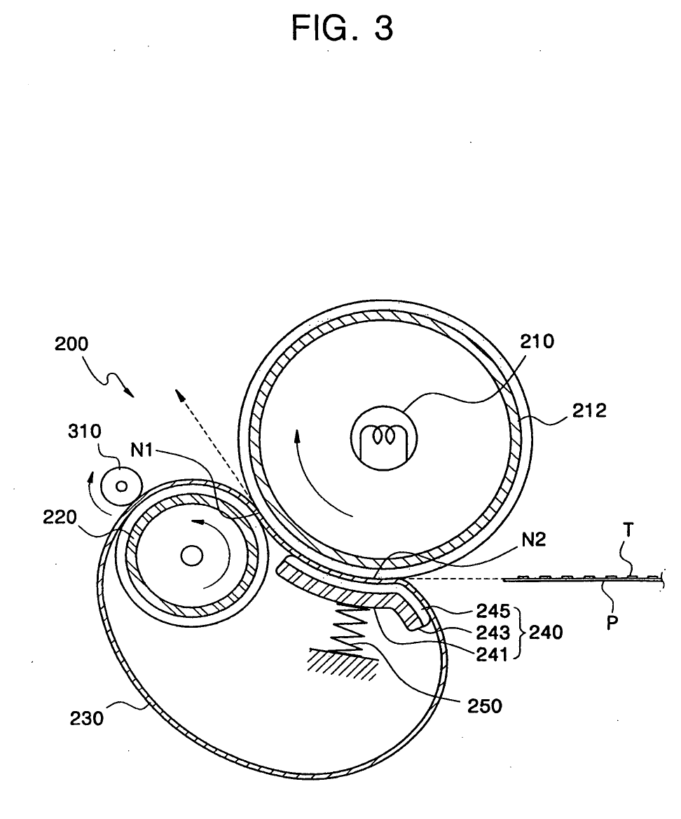

FIG. 3 is a side view illustrating the fixing device 200 of the image forming apparatus 100 of FIG. 1 according to another embodiment of the present general inventive concept.

Referring to FIG. 3, a pinch roller 310 that rotates in an opposite direction to the rotating direction of the pressure roller 220, with the fixing belt 230 interposed between the pinch roller 310 and the pressure roller 220, is provided. The pinch roller 310 is pressed toward the pressure roller 220, and applies tension to the fixing belt 230. A driving force generated by the pinch roller 310 is transmitted to the fixing belt 230, in addition to the driving force generated by the heat roller 212 and/or the pressure roller 220, thereby making the fixing belt 230 travel stably.

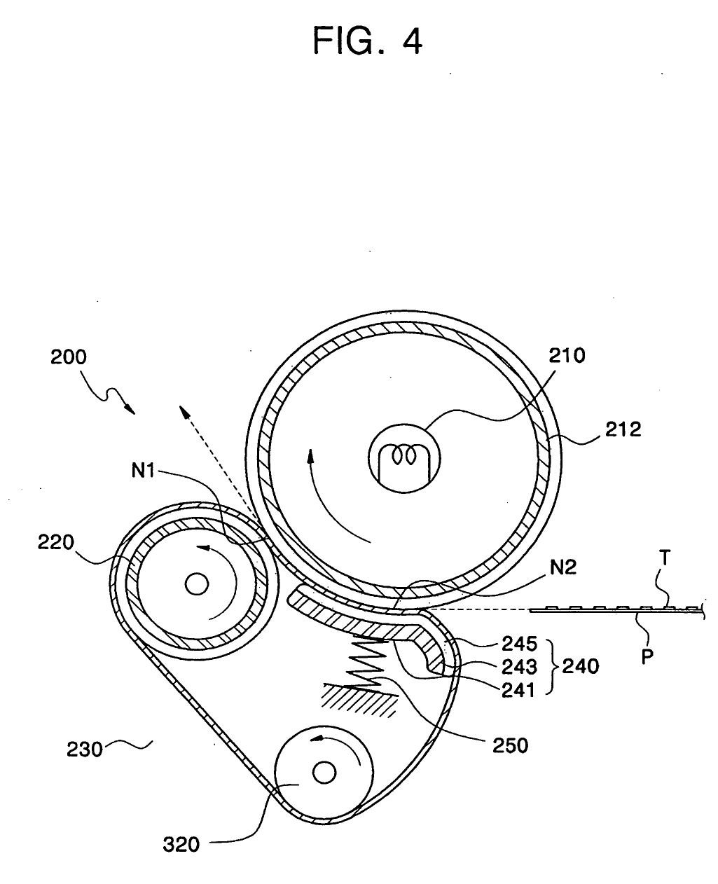

FIG. 4 is a side view illustrating the fixing device 200 of the image forming apparatus 100 FIG. 1 according to another embodiment of the present general inventive concept.

Referring to FIG. 4, in order to keep the fixing belt tight, a tension roller 320 that rotates in the same direction as the pressure roller 220 while pressing the fixing belt 230 in an outward direction is provided. The tension roller 320 is disposed between a position where the fixing belt 230 passes through the pressure roller 220 and a position where the fixing belt 230 comes into contact with the pressure member 240. The fixing belt 230 is tightened by the tension roller 320, thereby making the fixing belt 220 travel stably.

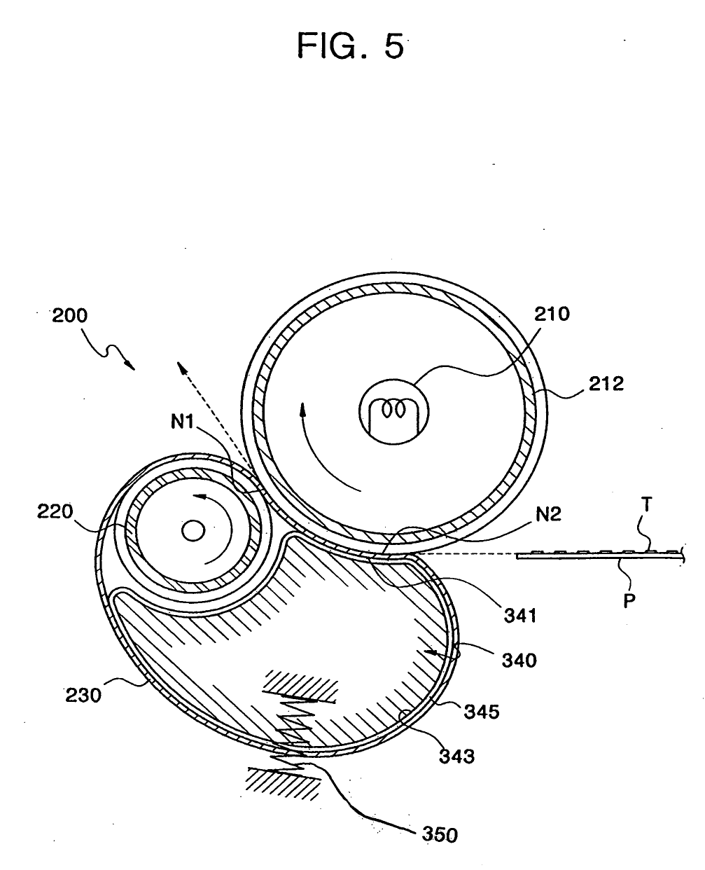

FIG. 5 is a side view illustrating the fixing device 200 of the image forming apparatus 100 of FIG. 1 according to another embodiment of the present general inventive concept.

Referring to FIG. 5, a pressure member 340 includes a pressure zone 341 that presses the fixing belt 230 along the outer surface of the heat roller 212 to form a second fixing nip N2, and a guide zone 343 that guides the fixing belt 230 into the second fixing nip N2.

The pressure zone 341 is formed to correspond to the profile of the outer circumferential surface of the heat roller 212 and causes the pressure member 340 to come into contact with the fixing belt 230. When the pressure zone 341 presses the fixing belt 230 toward the heat roller 212, a uniform pressure is applied to the second fixing nip N2 that is formed between the fixing belt 230 and the heat roller 212.

The pressure zone 341 may have a length from a location where the printing medium P having the toner image is introduced toward the heat roller 212 to a location of the first fixing nip N1. If necessary, the pressure zone 341 may have a length smaller than the above-described length. The length at which the pressure zone 341 presses the heat roller 212 becomes the second fixing nip N2.

The guide zone 343 is formed in order to guide the fixing belt 230 toward the pressure zone 341. After passing the second fixing nip N2, the fixing belt 230 travels around the pressure roller 220 to be in contact with the guide zone 343. Then, the fixing belt 230 passes through the guide zone 343 to proceed toward the pressure zone 341.

The pressure member 340 is provided with an elastic layer 345 (formed of, for example, rubber or silicon) on an outer circumferential surface of the pressure member 340. The elastic layer 345 allows the pressure zone 341 to be in closer contact with the fixing belt 230, and reduces friction between the guide zone 343 and the fixing belt 230. Further, a release layer (not illustrated) may be formed on the elastic layer 345.

In order to press the pressure member 340 toward the heat roller 212, a resilient member 350 is provided. The resilient member 350 has one end fixed to the main body 110 and the other end coupled to the pressure member 340 and resiliently pushes the pressure member 340 toward the heat roller 212.

As can be seen from the foregoing, according to the present general inventive concept, a pressure member is provided upstream from where a printing medium is conveyed to a pressure roller in the conveying direction. The printing medium sequentially passes through a second fixing nip formed by the pressure member and a first fixing nip formed by the pressure roller, thereby fixing a toner image. Therefore, the second fixing nip N2 generated by the pressure member increases a total fixing area of a fixing device. The increase of the fixing area increases a time during which the printing medium is fixed, so that fixing efficiency can be improved. Further, a fixing temperature may be set to a lower temperature, so that the warm-up time may be reduced.

According to various embodiments of the present general inventive concept, a pressure member presses along an outer circumferential surface of a heat roller to form a fixing nip. The fixing nip formed by the pressure member is subjected to a uniform pressure, so that printing quality can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A fixing device, comprising:
a heat roller;
a pressure roller disposed opposite to the heat roller to press the heat roller;
a fixing belt to be driven between the heat roller and the pressure roller and pressed by the pressure roller, and to fix a toner image on a printing medium as the printing medium passes between the fixing belt and the heat roller; and
a pressure member positioned upstream of the pressure roller in a direction in which the printing medium is conveyed, to press the fixing belt along an outer circumferential surface of the heat roller, and to fix the toner image on the printing medium as the printing medium passes between the pressed fixing belt and the heat roller,
wherein the pressure member applies a first tension to the fixing belt at a location between the pressure roller and the heat roller that is different from a second tension of the fixing belt at a location other than the location between the pressure roller and the heat roller.

2. The fixing device as set forth in claim 1, wherein the pressure member has an elastic layer on an outer surface thereof in contact with the fixing belt.

3. The fixing device as set forth in claim 2, further comprising:
a resilient member to press the pressure member toward the heat roller.

4. The fixing device as set forth in claim 1, further comprising:
a pinch roller to rotate in a direction opposite to the pressure roller,
wherein the fixing belt is interposed between the pinch roller and the pressure roller.

5. The fixing device as set forth in claim 1, further comprising:
a tension roller to apply tension to the fixing belt.

6. The fixing device as set forth in claim 1, wherein the pressure member comprises:
a pressure portion formed along the outer circumferential surface of the heat roller; and
a guide portion to guide the fixing belt toward the pressure portion.

7. The fixing device as set forth in claim 1, wherein the pressure member comprises:
a pressure zone formed along the outer circumferential surface of the heat roller; and
a guide zone along which the fixing belt is wound and moved to guide the fixing belt toward the pressure zone.

8. The fixing device as set forth in claim 1, wherein the pressure member is formed of a positive temperature coefficient material.

9. A fixing device to fix a toner image transferred to a printing medium passing through a plurality of fixing nips, the fixing device comprising:
first and second rollers rotatable in opposite directions to each other;
a fixing belt to be driven between the first and second rollers; and
a pressure member to press the fixing belt along an outer circumferential surface of the first roller and to form a second fixing nip between the first roller and the fixing belt corresponding to the pressure member,
wherein, after passing through the second fixing nip, the printing medium passes through a first fixing nip formed between the first roller and the fixing belt corresponding to the second roller while the second roller presses the first roller, and
wherein the pressure member applies a first tension to the fixing belt at the first and second fixing nips that is different from a second tension of the fixing belt at a location other than the first and second fixing nips.

10. The fixing device as set forth in claim 9, wherein the pressure member has an elastic layer formed on an outer surface thereof to be in contact with the fixing belt.

11. The fixing device as set forth in claim 9, further comprising:
a resilient member to press the pressure member toward the heat roller.

12. The fixing device as set forth in claim 9, further comprising:
a pinch roller to rotate in a direction opposite to the pressure roller, wherein the fixing belt is interposed between the pinch roller and the pressure roller.

13. The fixing device as set forth in claim 9, further comprising:
a tension roller to apply tension to the fixing belt.

14. The fixing device as set forth in claim 9, wherein the pressure member comprises:
a pressure portion formed along the outer circumferential surface of the heat roller; and
a guide portion to guide the fixing belt toward the pressure portion.

15. The fixing device as set forth in claim 9, wherein the pressure member comprises:
a pressure zone formed along the outer circumferential surface of the heat roller; and
a guide zone along which the fixing belt is wound and moved to guide the fixing belt toward the pressure zone.

16. The fixing device as set forth in claim 9, wherein the pressure member is formed of a positive temperature coefficient material.

17. An image forming apparatus, comprising:
an image forming section to transfer a toner image from a photoconductor to a printing medium; and
a fixing device to fix the toner image on the printing medium,
wherein the fixing device includes:
a heat roller to be heated to a fixing temperature,
a pressure roller disposed opposite to the heat roller to press the heat roller,
a fixing belt to be driven between the heat roller and the pressure roller and pressed by the pressure roller, and to fix the toner image on the printing medium as the printing medium passes between the fixing belt and the heat roller, and
a pressure member positioned upstream of the pressure roller in a direction in which the printing medium is conveyed, to press the fixing belt along an outer circumferential surface of the heat roller, to fix the toner image on the printing medium as the printing medium passes between the pressed fixing belt and the heat roller, and to apply a first tension to the fixing belt at a location between the heat roller and the pressure roller that is different from a second tension of the fixing belt at a location other than the location between the heat roller and the pressure roller.

18. The image forming apparatus as set forth in claim 17, wherein the pressure member comprises:
a pressure portion formed along the outer circumferential surface of the heat roller; and
a guide portion to guide the fixing belt toward the pressure portion.

19. The image forming apparatus as set forth in claim 17, wherein the pressure member comprises:
a pressure zone formed along the outer circumferential surface of the heat roller; and
a guide zone along which the fixing belt is wound and moved to guide the fixing belt toward the pressure zone.

20. The image forming apparatus as set forth in claim 17, further comprising:
a pinch roller to rotate in a direction opposite to the pressure roller, wherein the fixing belt is interposed between the pinch roller and the pressure roller.

21. A fixing device usable in an image forming apparatus, comprising:
a heat roller;
a fixing belt;
a pressure roller to press a first portion of the belt toward a first portion of the heat roller to form a first fixing nip; and
a pressure member spaced-apart from the pressure roller to press a second portion of the belt toward a second portion of the heat roller to form a second fixing nip, and to apply a first tension to the fixing belt at the first and second fixing nips that is different from a second tension of the belt at a location other than the first and second fixing nips.

22. The fixing device as set forth in claim 1, wherein the first tension is stronger than the second tension.

23. The fixing device as set forth in claim 9, wherein the first tension is stronger than the second tension.

24. The image forming apparatus as set forth in claim 17, wherein the first tension is stronger than the second tension.

25. The fixing device as set forth in claim 21, wherein the first tension is stronger than the second tension.

26. A fixing device usable in an image forming apparatus, comprising:
a heat roller;
a fixing belt;
a pressure roller to press a first portion of the belt toward a first portion of the heat roller to form a first fixing nip; and
a pressure member formed of a positive temperature coefficient material and spaced-apart from the pressure roller to press a second portion of the fixing belt toward a second portion of the heat roller to form a second fixing nip

27. The fixing device as set forth in claim 26, further comprising:
at least one of a pinch roller disposed on an opposite side of the fixing belt with respect to the pressure roller to rotate in a direction opposite to the pressure roller, and a tension roller to apply tension to the fixing belt.
